(19) United States
(12) Patent Application Publication
(10) Pub. No.: US 2014/0121954 A1
(43) Pub. Date: May 1, 2014

(54) APPARATUS AND METHOD FOR ESTIMATING VELOCITY OF A VEHICLE

(71) Applicant: HYUNDAI MOTOR COMPANY, Seoul (KR)

(72) Inventors: Hui Sung Lee, Gunpo (KR); Kyung Ho Yoo, Seoul (KR); Jin Hak Kim, Suwon (KR); Kyoung Moo Min, Yangju (KR)

(73) Assignee: Hyundai Motor Company, Seoul (KR)

(21) Appl. No.: 13/714,225

(22) Filed: Dec. 13, 2012

(30) Foreign Application Priority Data
Oct. 30, 2012 (KR) 10-2012-0121565

(51) Int. Cl. G08G 1/052

(52) U.S. Cl. CPC G08G 1/052
USPC 701/119

(57) ABSTRACT

Disclosed is an apparatus and a method for estimating velocity of a vehicle. The apparatus includes a surrounding environment information acquisition unit that acquires surrounding environment information of the vehicle from at least one sensor; a distance information extraction unit that extracts, from the surrounding environment information, distance information between the vehicle and objects in the vicinity of the vehicle; a group setting unit that classifies and groups the distance information according to a preset reference; a velocity calculation unit that calculates relative velocities between the vehicle and the objects for each group set; and a velocity estimation unit that estimates the velocity of the vehicle based on velocity values having the highest generation frequency from among the calculated relative velocities for each group.

### CROSS-REFERENCE TO RELATED APPLICATION

This application is based on and claims priority from Korean Patent Application No. 10-2012-0121565, filed on Oct. 30, 2012 in the Korean Intellectual Property Office, the disclosure of which is incorporated herein in its entirety by reference.

### BACKGROUND OF THE INVENTION

1. Field of the Invention

The present invention relates to an apparatus and a method for is estimating a velocity of a vehicle, and more particularly, to an apparatus and a method for estimating a velocity of a vehicle based on a relative velocity between the vehicle and fixed bodies in the vicinity of the vehicle.

2. Description of the Prior Art

Generally, velocity of a vehicle is estimated based on a velocity sensor mounted on a steering wheel, an acceleration sensor, or a difference between past and current positions of a vehicle that are acquired through a GPS. Recently, velocity estimates have been made by analyzing an image of a bottom of a vehicle or attaching an encoder to a wheel of a vehicle.

For example, Korean Patent Application No. 2010-0033581 describes a technique in which deceleration and acceleration of a vehicle are estimated by using engine torque information and sensor information, such as brake pressure and the like, according to a driving condition and a control condition of the vehicle. Based on the estimated deceleration and acceleration, an estimate of the reference velocity of the vehicle is made

However, with these techniques, errors and difficulties may occur. For example, in the technique which utilizes a velocity sensor mounted on a steering wheel, an error may result from sliding of the wheel at the time the velocity is measured through the sensors. I In the case of GPS, it is difficult to estimate velocity of a vehicle in a shadowy area. Further, in the technique which analyzes an image of a bottom of a vehicle, expensive equipment is necessary for processing the image.

### SUMMARY OF THE INVENTION

The present invention provides an apparatus and a method for estimating velocity of a vehicle which utilizes information acquired from objects in the vicinity of the vehicle. In particular, the present method facilitates estimation of relative velocity by classifying and grouping distance information acquired from objects in the vicinity of the vehicle, wherein each distance information of the same objects or adjacent objects is grouped according to a specific reference.

The present invention further provides an apparatus and a method for estimating velocity of a vehicle that simplifies a velocity estimation calculation without requiring a separate apparatus and system. In particular, by comparing velocity values calculated for each group to estimate velocity values of fixed bodies (relative to the vehicle), an estimated velocity of the vehicle is calculated.

In one aspect of the present invention, there is provided an apparatus for estimating velocity of a vehicle, including: a surrounding environment information acquisition unit configured for acquiring surrounding environment information of the vehicle from at least one sensor mounted in the vehicle; a distance information extraction unit configured for extracting distance information (distance between the vehicle and objects in the vicinity of the vehicle) from among the surrounding environment information acquired by the sensor; a group setting unit that classifies and groups the distance information between the vehicle and the objects in the vicinity of the vehicle according to a preset reference; a velocity calculation is unit that calculates relative velocities between the vehicle and the objects for each group set by the group setting unit; and a velocity estimation unit that estimates the velocity of the vehicle based on velocity values having the highest generation frequency among the relative velocities between the vehicle and the objects calculated for each group.

According to various embodiments, the surrounding objects include fixed bodies, and the velocity value having the highest generation frequency (the velocity value that is calculated most frequently) is a relative velocity between the fixed bodies located in the vicinity of the vehicle and the vehicle.

According to various embodiments, the group setting unit classifies the distance information based on a relative position of the surrounding objects and a continuing change in distance values.

According to various embodiments, the distance information is based on the acquired position of surrounding objects and distance values between the objects and the vehicle. As such, the group setting unit may be configured to classify the distance information in the same group when a difference between the distance values of adjacent positions is within a reference value. The group setting unit may further be configured to classify the distance information in different groups when the difference of distance values of adjacent positions exceeds the reference value.

According to various embodiments, the sensor is a sensor, such as, LIDAR, ToF camera, and the like, that transmits the distance value of the surrounding objects as data.

In another aspect of the present invention, there is provided a is method for estimating velocity of a vehicle, including: acquiring surrounding environment information of the vehicle from at least one sensor mounted in the vehicle; extracting distance information between the vehicle and objects in the vicinity of the vehicle from among the surrounding environment information acquired by the sensor; classifying and grouping the distance information (distance between the vehicle and the objects in the vicinity of the vehicle) according to a preset reference value; calculating a relative velocity between the vehicle and the objects for each group; and estimating the velocity of the vehicle based on velocity values having the highest generation frequency from among the relative velocities (velocities between the vehicle and the objects) calculated for each group.

### BRIEF DESCRIPTION OF THE DRAWINGS

The above and other objects, features and advantages of the present invention will be more apparent from the following detailed description taken in conjunction with the accompanying drawings, in which:

FIG. 1 is a reference diagram describing a configuration of an apparatus for estimating velocity of a vehicle according to an embodiment of the present invention;

FIG. 2 is a block diagram illustrating an apparatus for estimating velocity of a vehicle according to an embodiment of the present invention;

FIGS. 3A and 3B to 6 are illustrative reference diagrams describing an operation of calculating relative velocities between surrounding objects of the apparatus for estimating velocity of a vehicle according to an is embodiment of the present invention; and

FIG. 7 is a flow chart illustrating an operation flow of a method for estimating velocity of a vehicle according to an embodiment of the present invention. It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE PREFERRED EMBODIMENTS

Hereinafter, preferred embodiments of the present invention will be described in detail with reference to the accompanying drawings.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other is alternative fuel vehicles (e.g. fuels derived from resources other than petroleum). As referred to herein, a hybrid vehicle is a vehicle that has two or more sources of power, for example both gasoline-powered and electric-powered vehicles.

Additionally, it is understood that the below methods are executed by at least one controller. The term controller refers to a hardware device that includes a memory and a processor. The memory is configured to store the modules and the processor is specifically configured to execute said modules to perform one or more processes which are described further below.

Furthermore, the control logic of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a,” “an” and “the” are is intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.

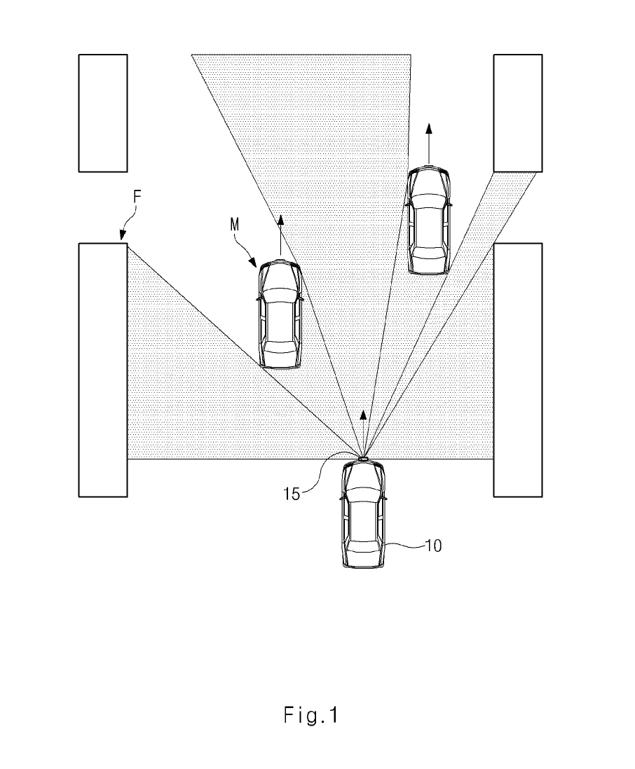

FIG. 1 is a reference diagram describing a configuration of an apparatus for estimating velocity of a vehicle according to an embodiment of the present invention. Referring to FIG. 1, a vehicle 10 is provided with at least one surrounding environment detection sensor 15 that detects a surrounding environment of the vehicle 10 at any time. Thus, for example, the surrounding environment detection sensor 15 can detect the is surrounding environment information of the vehicle 10 when the vehicle 10 is parked, at a stop, or while the vehicle 10 is moving. In this case, the surrounding environment detection sensor 15 can include at least one sensor that transmits distance values of objects such as LIDAR, ToF camera, and the like, as data. The surrounding environment information detected by the surrounding environment detection sensor 15 includes the distance information on the surrounding objects (distance between the surrounding objects and the vehicle 10).

Here, the surrounding objects may correspond to mobile bodies M and fixed bodies F. According to an embodiment, the surrounding objects correspond to the fixed bodies F when there are no mobile bodies M in the vicinity of a vehicle. In other words, according to an embodiment of the present invention, it is assumed that fixed bodies F are necessarily located in the vicinity of the vehicle 10. In order to accurately estimate velocity of the vehicle, it is preferred that a large number of fixed bodies F are located in the vicinity of the vehicle 10.

For example, as illustrated in FIG. 1, the surrounding environment detection sensor 15 of the vehicle 10 detects distance information of the fixed bodies F located to a side or a diagonal side of the vehicle 10, and further detects distance information of the mobile bodies M in front of the vehicle 10.

In this case, the apparatus for estimating velocity of a vehicle acquires surrounding environment information detected by at least one surrounding environment detection sensor 15. The apparatus is configured to extract the distance information from among the surrounding environment information and to group the distance information according to preset conditions. After extracting and grouping the distance information, the apparatus then compares relative velocity values for each group and estimates, as the velocity of the vehicle 10, a velocity value having a high generation frequency (a most common velocity value, also referred to as a mode).

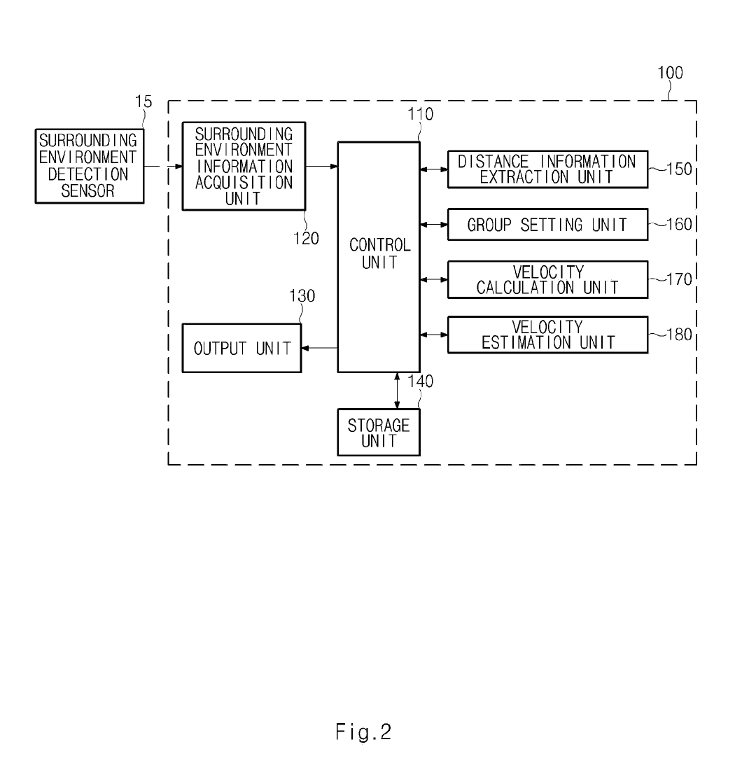

A configuration of an apparatus for estimating velocity of a vehicle 10 according to an embodiment of the present invention will be described below in detail with reference to FIG. 2.

Referring to FIG. 2, the apparatus 100 for estimating velocity of the vehicle invention includes a control unit 110, a surrounding environment information acquisition unit 120, an output unit 130, a storage unit 140, a distance information extraction unit 150, a group setting unit 160, a velocity calculation unit 170, and a velocity estimation unit 180. According to the depicted embodiment, the control unit 110 controls an operation of each unit of the vehicle velocity estimation apparatus 100.

The surrounding environment information acquisition unit 120 is in connection with at least one surrounding environment detection sensor 15 mounted in the vehicle 10. The surrounding environment information is acquisition unit 120 is configured so as to acquire the surrounding environment information of the vehicle 10 from the surrounding environment detection sensor 15. As described above, the surrounding environment detection sensor 15 includes at least one sensor for measuring a distance such as LIDAR, ToF, and the like. The surrounding environment information detected by the surrounding environment detection sensor 15 includes distance information on the surrounding objects. Preferably, the surrounding environment information includes the distance information on fixed bodies F in the vicinity of the vehicle 10.

The output unit 130 is configured to output operation status data of the apparatus 100 and estimated results of velocity of the vehicle 10. Here, the output unit 130 may correspond to a vehicle display, a speaker, and the like, and may display the estimated results of velocity of the vehicle 10 on the vehicle display or may output the estimated results as a voice signal through the speaker.

The storage unit 140 is configured for storing a setting value for the operation of the apparatus 100 for estimating velocity of a vehicle, and the like. According to various embodiments, the storage unit stores operation result values, for example, surrounding environment information, group information, velocity information, and the like.

The distance information extraction unit 150 is configured for extracting the distance information from among the surrounding environment information acquired by the surrounding environment detection sensor 15. In particular, the distance information extraction unit 150 can be configured to extract the distance information on the is surrounding objects located in the vicinity of the vehicle, for example, the mobile bodies M and the fixed bodies F.

The group setting unit 160 is configured for classifying and grouping the distance information on the surrounding objects according to the preset reference. In this case, the group setting unit 160 may classify the distance information based on the relative position of the surrounding objects and the change in the distance values (the continued positions of the objects as the vehicle travels). In particular, the group setting unit 160 may be configured to classify the distance information in the same group when the difference between the distance values of the adjacent positions is within a reference value (based on the acquired position and distance values). The group setting unit 160 would then classify the distance information as different groups when the difference of the distance values of the adjacent positions exceeds the reference value (based on the acquired position and distance values).

The velocity calculation unit 170 is configured for calculating the relative velocities between the vehicle and the surrounding objects for each of groups that are set by the group setting unit 160. For example, the velocity calculation unit 170 can be configured to calculates the relative velocities between the vehicle and the surrounding objects within each group by dividing distance change vectors of each group by time.

The velocity estimation unit 180 is configured for estimating the velocity of the vehicle based the velocity value having the highest generation frequency (mode) from among the relative velocities of each group calculated by the velocity calculation unit 170. According to certain embodiments, the fixed bodies F are located more in the vicinity of a vehicle than the mobile bodies M and therefore, the velocity value having the highest generation frequency becomes the relative velocity values between the fixed bodies F located in the vicinity of a vehicle and the vehicle.

In some cases, the velocity estimation unit 180 is configured to estimate the velocity values extracted from a predetermined time, that is, the average value of the velocity values having the highest generation frequency from among the relative velocities of each group. In some cases, if a velocity value has a large difference in its average value as compared with relative velocities of each group, the velocity value may be considered to be an erroneous calculation and may be temporarily extracted.

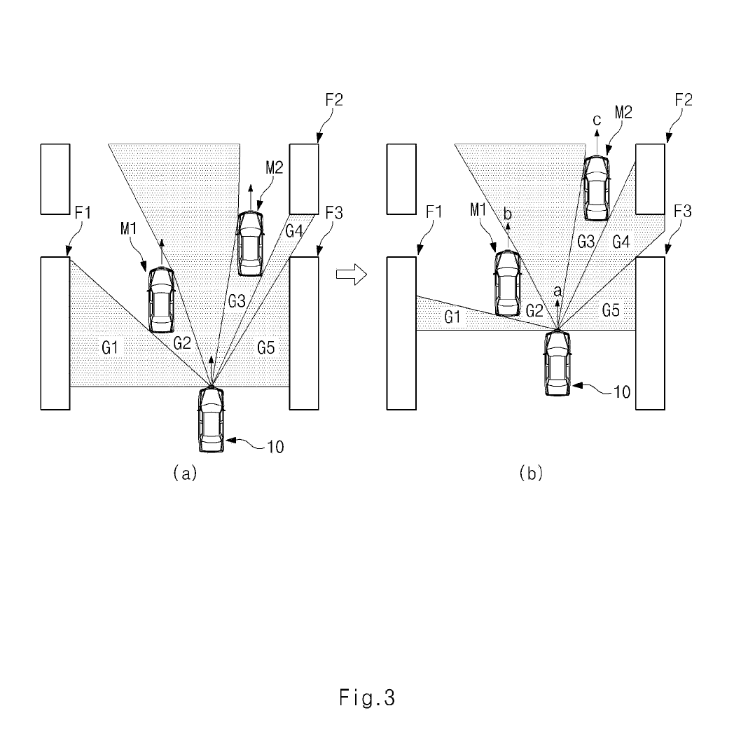

FIGS. 3 to 5 are illustrative reference diagrams which describe an operation of calculating relative velocities between surrounding objects of the apparatus 100 for estimating velocity of a vehicle 10 according to an embodiment of the present invention.

FIGS. 3A and 3B illustrate grouping of the distance information acquired from the surroundings of a vehicle when the vehicle 10 moves according to an embodiment. Referring to FIG. 3A, the vehicle 10 acquires the surrounding environment information at a current vehicle position, and the apparatus 100 for estimating velocity of the vehicle extracts the distance information from among the acquired surrounding environment information and groups the extracted distance information.

For example, the apparatus 100 for estimating velocity of the vehicle may group the distance information G1 from the fixed bodies F1 located in the left direction of the vehicle 10, and may group the distance information is from the mobile bodies M1 located in the left diagonal direction as G2. In this case, the distance information from the fixed bodies F1 and the distance information from the mobile bodies M1 are classified as different groups since the fixed bodies and the mobile bodies are adjacent to each other, or the difference in the distance change (change in distance between the bodies, F1 and M1, and the vehicle 10 as the vehicle travels) is large. For example, because the fixed body F1 does not move as the vehicle 10 travels, the distance change (change in distance between the vehicle 10 and the fixed body F1) will generally by larger as compared to the distance change (change in distance between the vehicle 10 and the mobile body M1) as the vehicle 10 travels if the mobile body M1 moves along the same direction as the vehicle 10.

Similarly, the apparatus for estimating velocity of a vehicle groups the distance information from the mobile bodies M2 located in the right diagonal direction of the vehicle 10 as G3, groups the distance information from the fixed bodies F2 located in the right diagonal direction as G4, and groups the distance information from the fixed bodies F3 located in the right direction as G5.

In this case, the distance information from the mobile bodies M2 located in the right diagonal direction and the distance information from the fixed bodies F2, F3 are classified as different groups since the fixed bodies F2, F3 and the mobile bodies M2 are adjacent to each other, or the difference in the distance change (change in distance between the bodies, F2, F3 and M2, and the vehicle 10 as the vehicle travels) is large. Further, the distance information from the fixed bodies F2 located in the right is diagonal direction and the fixed bodies F3 located in the right direction are classified as different groups since the fixed bodies F2, F3 and the mobile bodies M2 are adjacent to each other or the difference in the distance change is large. If the two fixed bodies F2, F3 are adjacent to each other and thus, the difference in the distance change is not large, the distance information from the two fixed bodies F2, F3 may be grouped into one group.

As illustrated in FIG. 3A, when the vehicle 10 is driven in the state in which the distance information is grouped, the positions of the vehicle 10 and the mobile bodies M1, M2 are changed and the position of the fixed bodies F1, F2, F3 is fixed as it is as illustrated in FIG. 3B.

In FIG. 3B, the vehicle 10 moves by a distance “a” per unit of time, the mobile body M1 of G2 moves by a distance “b” per unit of time, and the mobile body M2 of G3 moves by a distance “c” per unit of time. Therefore, as the vehicle 10 moves, the distance change vectors of the mobile bodies M1, M2 and the fixed bodies F1, F2, F3 in the vicinity of the vehicle 10 are different.

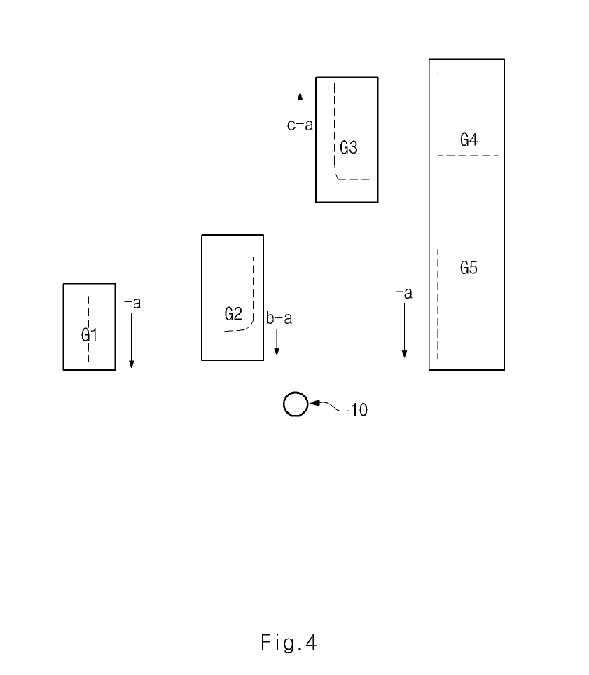

In this case, the apparatus for estimating velocity of the vehicle 10 calculates velocity using the distance change vectors for each group. In this case, the velocity information calculated by the apparatus for estimating velocity of a vehicle is illustrated in FIG. 4.

Referring to FIG. 4, since the position of the fixed body F1 of the G1 group is fixed, the velocity is calculated based on the distance change vector of the vehicle 10. In this case, the calculated velocity of the G1 group becomes −a. Likewise, in the case of the G4 group and the G5 group, since the positions of the fixed bodies F3, F3 are not changed, the velocities are calculated based on the distance change vector of the vehicle 10. In this case, all the calculated velocities (for fixed bodies F1, F2, and F3) become −a.

Meanwhile, since the mobile body M1 of the G2 group moves by “b” per time and the vehicle 10 moves by “a” per unit time, the velocity is calculated based on the distance change vector of the mobile body M1 of the G2 group and the vehicle 10. In this case, the calculated velocity of the G2 group becomes b−a.

Further, since the mobile body M2 of the G3 group moves by “c” per time and the vehicle 10 moves by “a” per unit time, the velocity is calculated based on the distance change vector of the mobile body 2 of the G3 group and the vehicle 10. In this case, the calculated velocity of the G3 group becomes c−a.

In the case of the embodiment shown by FIG. 4, since the frequency of −a among the velocity values calculated for each group is the highest, the apparatus 100 for estimating velocity of the vehicle may estimate −a as the velocity of the vehicle.

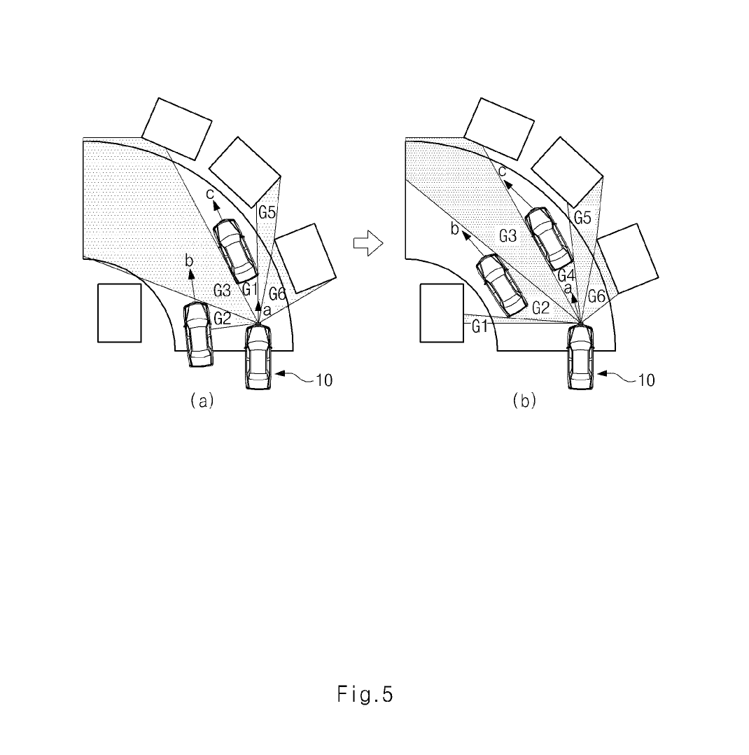

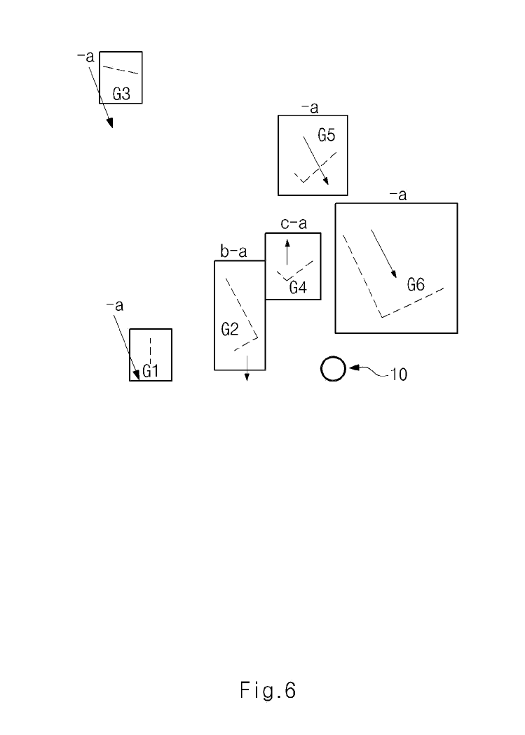

FIGS. 5 and 6 illustrate an operation for estimating velocity of a vehicle on a curved road as another embodiment of the invention. Referring to FIGS. 5A and 5B, when a vehicle acquires the distance information on four fixed bodies and two mobile bodies located in the vicinity of the vehicle 10, the apparatus 100 for estimating velocity of the vehicle 10 groups the acquired distance information.

For example, FIGS. 5A and 5B illustrate a first fixed body, a second is fixed body, a third fixed body, and a fourth fixed body from the left to the right and similarly illustrate a first mobile body and a second mobile body from the left to the right.

In this case, the apparatus for estimating velocity of a vehicle 10 groups the distance information on the first fixed body as G1, the distance information on the mobile body as G2, the distance information on the second fixed body as G3, the distance information on the second mobile body as G4, the corresponding distance information on the third fixed body as G5, and the distance information on the fourth fixed body as G6.

In FIG. 5B, when a predetermined time lapses (a unit of time) the vehicle 10 moves by a distance “a” per unit time, the second mobile body of G2 moves by a distance “b” per unit time, and the third mobile body of G3 moves by a distance “c” per unit time. Therefore, as the vehicle 10 moves, the distance change vectors of the first mobile body, the second mobile body, and the fixed bodies in the vicinity of the vehicle 10 are different.

In this case, the apparatus 100 for estimating velocity of the vehicle 10 calculates velocity using the distance change vectors for each group and the calculated velocities for each group based on each distance change vector are illustrated in FIG. 6.

Referring to FIG. 6, since the positions of the fixed bodies of G1, G3, G5, and G6 groups are fixed, the velocities are calculated based on the distance change vector of the vehicle 10. In this case, all of the calculated velocities of the G1, G3, G5, and G6 groups become −a.

Meanwhile, since the first mobile body moves by “b” per unit time and the vehicle moves by “a” per unit time, the velocity of the G2 group is is calculated based on the distance change vector of the first mobile body and the vehicle 10. In this case, the calculated velocity of the G2 group becomes b−a. Further, since the second mobile body moves by “c” per unit time and the vehicle 10 moves by “a” per unit time, the velocity of the G4 group is calculated based on the distance change vector of the second mobile body and the vehicle 10. In this case, the calculated velocity of the G4 group becomes c−a.

Thus, in the case of FIG. 6, since the frequency of −a from among the velocity values calculated for each group is the highest, the apparatus 100 for estimating velocity of the vehicle may estimate −a as the velocity of the vehicle 10.

A method for estimating velocity of a vehicle according to the embodiment of the present invention configured as described above will be described below in more detail.

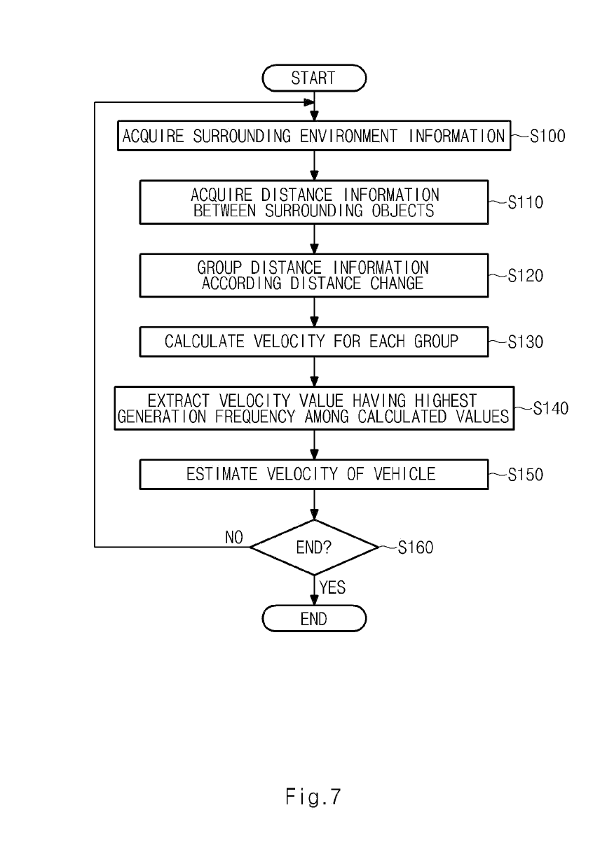

FIG. 7 is a flow chart illustrating a method for estimating velocity of the vehicle 100 according to the embodiment of the present invention. Referring to FIG. 7, the apparatus 100 for estimating velocity of the vehicle 100 according to the embodiment of the present invention acquires the surrounding environment information through the surrounding environment detection sensor 15 mounted in the vehicle 10 (S100).

In this case, the apparatus 100 acquires the distance information between the surrounding objects from among the surrounding environment information acquired in ‘S100’ (S110), and groups the distance information acquired in ‘S110’ according to the relative positions of the surrounding objects, the degree of change of continued distance values, and the like (S120).

Next, the apparatus 100 calculates the velocities for each group by using the distance change vector of the surrounding objects and the vehicle (S130), and extracts the velocity value having the highest generation frequency from among the values calculated in ‘S130’ (S140). The apparatus 100 then estimates the velocity of the vehicle 10 as the velocity value having the highest generation frequency (S150).

‘S100’ to ‘S150’ may be repeatedly performed while driving the vehicle 10 until a separate ending command is input. When the ending command is input (S160), all the related operations end.

According to the embodiment of the present invention, the distance information acquired from objects in the vicinity of a vehicle is classified and grouped according to distance information of the same objects or adjacent objects according to the specific reference, thereby facilitating the estimation of relative velocity for each group. The velocity values of fixed bodies may be estimated as the velocity of the vehicle by comparing the velocity values calculated for each group. As a result, the velocity of a vehicle can be more accurately estimated. Further, a separate apparatus and system for estimating the velocity of a vehicle is not required, thereby saving costs.

The apparatus and method for estimating velocity of a vehicle according to the embodiment of the present invention are described with reference to the illustrated drawings, but the present invention is not limited to the embodiments and drawings disclosed in the present specification and therefore, may be variously modified within the technical scope of the present invention.

1. An apparatus for estimating a velocity of a vehicle, comprising:
a processor coupled to the network interfaces and configured to execute one or more processes; and
a memory configured to store a process executable by the processor, the process when executed operable to:
acquire surrounding environment information of the vehicle from at least one sensor that transmits distance values of surrounding objects;
extract distance information, the distance information being a distance between the vehicle and one or more objects in the vicinity of the vehicle, from among the surrounding environment information acquired by the sensor;
classify and group the distance information based on a relative position of the surrounding objects and a continuing change in the distance values;
calculate relative velocities between the vehicle and the one or more objects for each group set; and
estimate the velocity of the vehicle based on the relative velocity values having the highest generation frequency from among the relative velocities calculated for each group.

2. The apparatus according to claim 1, wherein the one or more surrounding objects include fixed bodies, and the velocity value having the highest generation frequency is a relative velocity between the fixed bodies located in the vicinity of the vehicle and the vehicle.

3. The apparatus according to claim 1, wherein the process is further when executed operable to:
classify the distance information based on a relative position of the surrounding objects and a change in distance values over time.

4. The apparatus according to claim 3, wherein the process is further when executed operable to:
classify the distance information in a common group when a difference between the distance values of adjacent positions is within a reference value; and
classify the distance information as different groups when the difference of the distance values of the adjacent positions exceeds the reference value, based on the acquired position and distance values.

5. The apparatus according to claim 1, wherein the sensor is one of a light detection and ranging (LIDAR) or a time of flight (ToF) camera.

6. A method for estimating velocity of a vehicle executed by a processor within a controller, comprising:
acquiring surrounding environment information of the vehicle from at least one sensor that transmits distance values of surrounding objects;
extracting distance information, the distance information being a distance between the vehicle and one or more objects in the vicinity of the vehicle, from among the surrounding environment information acquired by the sensor;
classifying and grouping the distance information based on a relative position of the surrounding objects and a continuing change in the distance values;
calculating a relative velocity between the vehicle and the objects for each group; and
estimating as the velocity of the vehicle based on the relative velocity values having the highest generation frequency from among the relative velocities between the vehicle and the objects calculated for each group.

7. The method according to claim 6, wherein the one or more surrounding objects include fixed bodies, and
the velocity value having the highest generation frequency is a relative velocity between the vehicle and the fixed bodies located in the vicinity of the vehicle.

8. The method according to claim 6, wherein in the grouping, the distance information is classified based on a relative position of the surrounding objects and a change in distance values over time.

9. The method according to claim 8, wherein in the grouping, the distance information is classified in the same group when a difference between the distance values of adjacent positions is within a reference value, and the distance information is classified in different groups when the difference of the distance values of the adjacent positions exceeds the reference value, based on the acquired position and distance values.

10. A non-transitory computer readable medium containing program instructions executed by a controller to estimate velocity of a vehicle, the computer readable medium comprising:
program instructions that acquire surrounding environment information of the vehicle from at least one sensor that transmits distance values of surrounding objects;
program instructions that extract distance information, the distance information comprising distances between the vehicle and one or more objects in the vicinity of the vehicle, from the surrounding environment information;
program instructions that classify and group the distance information based on a relative position of the surrounding objects and a continuing change in the distance values;
program instructions that calculate a relative velocity between the vehicle and the objects for each group; and
program instructions that estimate the velocity of the vehicle based on the relative velocity values having the highest generation frequency.
